(19) United States
(12) Patent Application Publication
(10) Pub. No.: US 2016/0011874 A1
(43) Pub. Date: Jan. 14, 2016

(54) SILENT MEMORY INSTRUCTIONS AND MISS-RATE TRACKING TO OPTIMIZE SWITCHING POLICY ON THREADS IN A PROCESSING DEVICE

(71) Applicants: DORON ORENSTEIN, Haifa (IL); TOMER STARK, Nesher (IL); CHEN DAN, Hadera (IL); JACOB DOWECK, Haifa (IL); ENRIC G. CODINA, Barcelona (ES); JOSEP M. CODINA, Hospitalet de Llobregat (ES); REKAI GONZALEZ-ALBERQUILLA, L'Hospitalet de Llobregat (ES); TANAUSU RAMIREZ, Barcelona (ES)

(72) Inventors: DORON ORENSTEIN, Haifa (IL); TOMER STARK, Nesher (IL); CHEN DAN, Hadera (IL); JACOB DOWECK, Haifa (IL); ENRIC G. CODINA, Barcelona (ES); JOSEP M. CODINA, Hospitalet de Llobregat (ES); REKAI GONZALEZ-ALBERQUILLA, L'Hospitalet de Llobregat (ES); TANAUSU RAMIREZ, Barcelona (ES)

(21) Appl. No.: 14/326,879

(22) Filed: Jul. 9, 2014

(51) Int. Cl. G06F 9/38; G06F 9/30

(52) U.S. Cl. CPC G06F 9/3806; G06F 9/3861; G06F 9/30058; G06F 9/30145

(57) ABSTRACT

A processing device implementing silent memory instructions and miss-rate tracking to optimize switching policy on threads is disclosed. A processing device of the disclosure includes a branch prediction unit (BPU) to predict that an instruction of a first thread in a current execution context of the processing device is a delinquent instruction, indicate that the first thread including the delinquent instruction is in a silent execution mode, indicate that the delinquent instruction is to be executed as a silent instruction, switch an execution context of the processing device to a second thread, and when the execution context returns to the first thread, cause the delinquent instruction to be re-executed as a regular instruction.

### TECHNICAL FIELD

The embodiments of the disclosure relate generally to processing devices and, more specifically, relate to silent memory instructions and miss-rate tracking to optimize switching policy on threads in a processing device.

### BACKGROUND

Modern processors and processor cores generally support multithreading to improve performance efficiency. Increasing the number of threads per core can bring higher performance to key applications. In processors that support the execution of multiple control flows or threads, a thread stalling due to performance disrupting events (such as level 1 (L1) cache misses, level 2 (L2) cache misses, last-level cache (LLC) misses, data translation lookaside buffer (dTLB) misses, and so on) often block critical processor resources. This may, in turn, degrade the performance of other threads. This is quite common in the server domain, in part due to large data applications. The observed instructions per cycle (IPC) in these scenarios is often far below the peak throughput of the processor.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a block diagram of a computing system, according to an embodiment of the disclosure.

FIG. 2 is a flow diagram illustrates a block diagram of switch decision logic, according to an embodiment of the disclosure.

FIG. 3 is a flow diagram illustrating a method for implementing silent memory instructions to optimize switching policy on threads in a processing device, according to an implementation of the disclosure.

FIG. 4 is a flow diagram illustrating a method for implementing silent memory instructions and miss-rate tracking to optimize switching policy on threads in a processing device, according to an implementation of the disclosure.

FIG. 5A is a block diagram illustrating a micro-architecture for a processor that implements silent memory instructions and miss-rate tracking to optimize switching policy on threads in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor that includes logic circuits to implement silent memory instructions and miss-rate tracking to optimize switching policy on threads in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure

FIG. 11 is a block diagram of an embodiment of a SoC design in accordance with the present disclosure.

FIG. 12 illustrates a block diagram of one embodiment of a computer system.

### DETAILED DESCRIPTION

Embodiments of the disclosure implement techniques for silent memory instructions and miss-rate tracking to optimize switching policy on threads in a processing device. Embodiments of the disclosure dynamically detect delinquent memory instructions (those suffering stalls due to cache misses), convert them into silent memory instructions and switch to another thread in an attempt to overlap the resolution of the stalling event with independent useful work from another thread. Once the event is resolved and the offending thread is a candidate for execution again, the instruction is executed as a regular memory instruction (probably hitting in the cache this time). In particular, a silent memory instruction is an instruction that: (i) resolves the event that causes the stall (cache miss), (ii) does not block critical resources of the processor such as ROB entries, (iii) does not produce an architectural result, and (iv) is re-executed in its original form when the processor deems the stalling event is solved.

The behavior of a silent instruction may be similar to a prefetch instruction. Memory instructions that are to be converted into a silent version are detected/predicted at the Branch Prediction Unit (BPU) of the processor, which decides whether to switch to another execution control flow in the next cycle. This silencing information is passed on to the Front End (FE) and to the Back End (BE) to decode and execute instructions appropriately.

Supporting multiple control flows of execution is an efficient technique to exploit execution resources. In multithreading machines it can be important to use mechanisms that decide when to switch between threads and to share processor resources in order to reduce the impact on each individual thread's performance. This is a challenge when any of the threads is memory bound (e.g., typical workloads in big data applications), as such threads are stalled most of the time and they consume backend resources, affecting the performance of other threads. Thus, mechanisms in which memory delinquent instructions are detected at runtime and are converted into their silent version to overlap the stalling event with work from other threads may be beneficial.

Previous solutions often employ different flavors of Switch-on-Event (SOE) techniques to partially overcome these stalls, which are controlled by the BE. In particular, in the previous solutions, when the BE detected a long stalling event, it flushed all instructions in the BE that belong to that thread and that are younger than the offending or delinquent instruction (i.e., the instruction that caused the miss or the stalling event). At that point, the offending thread was frozen and the BE resources were assigned to the other thread, which proceeded with execution. Once the stalling event is served, the offending thread was unfrozen and it was again a candidate for execution. Since these SOE techniques incur non-negligible overheads (in the order of tenths of cycles), switching is only performed in the presence of long latency events. In addition, such prior paradigms often implied duplicating some processor structures as instruction queues, which was beneficial mainly for in-order processors that did not have any ability to overlap stalls with computation.

Compared to these previous solutions, the embodiments of the disclosure described herein do not incur overhead in time when switching based on stalling events. The silent memory instructions described herein provide a technique to better share critical microprocessor resources among different threads and a technique that can be implemented on either isolated or on top of SMT or Hyperthreading platforms.

Although the following embodiments may be described with reference to specific integrated circuits, such as in computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to desktop computer systems or Ultrabooks™ and may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations described below.

Although the following embodiments are described with reference to a processor, other embodiments are applicable to other types of integrated circuits and logic devices. Similar techniques and teachings of embodiments of the disclosure can be applied to other types of circuits or semiconductor devices that can benefit from higher pipeline throughput and improved performance. The teachings of embodiments of the disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which includes processor logic and circuits used to implement one or more instruction sets. Accordingly, processors with different micro-architectures can share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT), a Reorder Buffer (ROB) and a retirement register file. In one embodiment, registers may include one or more registers, register architectures, register files, or other register sets that may or may not be addressable by a software programmer.

In one embodiment, an instruction may include one or more instruction formats. In one embodiment, an instruction format may indicate various fields (number of bits, location of bits, etc.) to specify, among other things, the operation to be performed and the operand(s) on which that operation is to be performed. Some instruction formats may be further broken defined by instruction templates (or sub formats). For example, the instruction templates of a given instruction format may be defined to have different subsets of the instruction format's fields and/or defined to have a given field interpreted differently. In one embodiment, an instruction is expressed using an instruction format (and, if defined, in a given one of the instruction templates of that instruction format) and specifies or indicates the operation and the operands upon which the operation will operate.

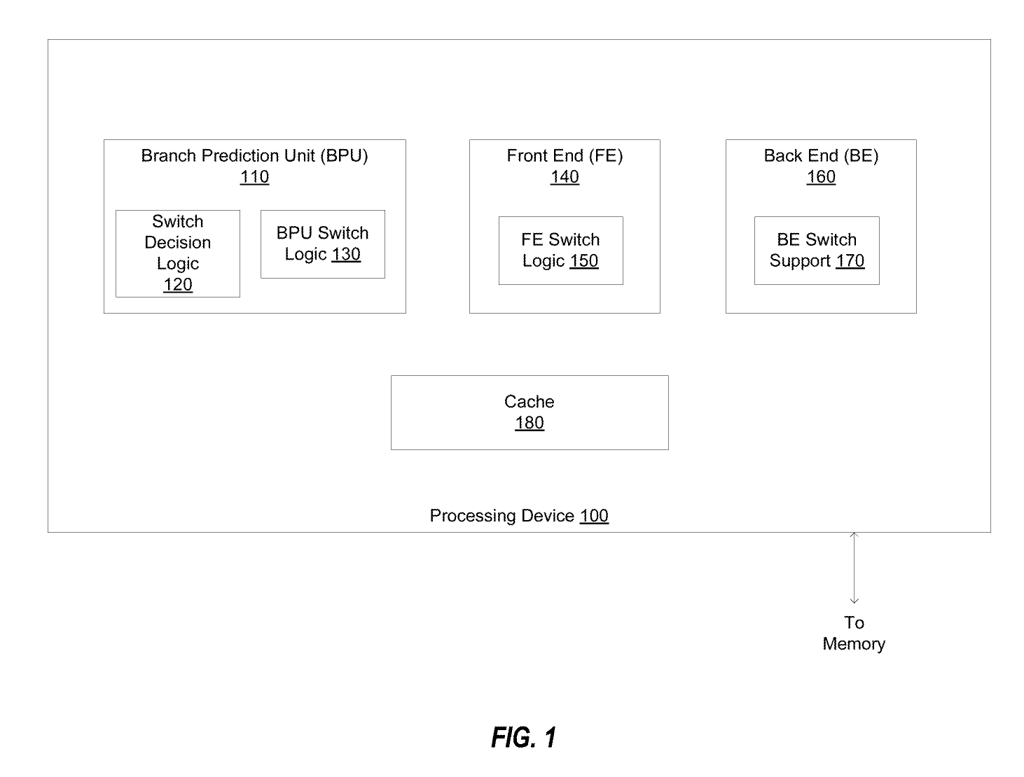

FIG. 1 illustrates a block diagram of a processing device 100. Processing device may also be generally referred to as “processor 100” or “CPU”. The processing device 100 may include various components. In one embodiment, processing device 100 may include a branch prediction unit (BPU) 110, a front end (FE) 140, a back end (BE) 160, and a cache 180 (which may include one or more private or shared caches), among other components.

The processing device 100 may also include a communication component (such as a router, a bus, an interconnection, a controller, etc.) that may be used to communicate between various components of the processing device 100 and/or other system components outside of the processing device 100. Moreover, the communication component may be in communication to enable data routing between various components inside or outside of the processing device 100. The processing device 100 may include one or more processor cores that may be implemented on a single integrated circuit (IC) chip. Moreover, the IC may include one or more shared and/or private caches (such as cache 180), buses or interconnections, memory controllers, or other components.

The cache 180 may store data (e.g., including instructions) that are utilized by one or more components of the processing device 100. For example, the cache 180 may locally cache data stored in a memory for faster access by the components of the processing device 100. The memory may be in communication with the processing device 100 via an interconnection. In one embodiment, the cache 180 may be a level 1 cache (L1), a level 2 (L2) cache, a last level cache (LLC), such as an L3 cache, or some variation of the above. Furthermore, the processing device 100 may also include a mid-level cache that is shared by several cores. Various components of the processor 100 may communicate with the cache 180 directly, through a bus and/or a memory controller or hub.

In one embodiment, processing device 100 dynamically predicts delinquent memory instructions (for example, those suffering stalls due to cache misses), and converts the predicted delinquent memory instructions into silent memory instructions. The silent memory instructions resolve solve the delinquency of the delinquent instruction without blocking critical pipeline resources of the processing device 100 by switching to another control flow of execution (i.e., another thread) in an attempt to overlap the resolution of the stalling event with independent work from another thread. The use of the term “thread” may refer to any type of control flow including, but not limited to, simultaneous multithreading (SMT) threads, fibers, hibers (hardware-assisted fibers), and so on.

Once the delinquency (e.g., cache miss) is resolved and the stalling thread resumed, the silent instruction is re-executed normally (e.g., now as hit on the cache). In particular, a silent memory instruction is an instruction that: (i) resolves the event that causes the stall (e.g., cache miss), (ii) does not block critical resources of the processing device, such as reorder buffer (ROB) entries, (iii) does not produce an architectural result, and (iv) is re-executed in its original form when the processing device 100 deems the stalling event is resolved. In one embodiment, the behavior of a silent instruction is quite similar to a prefetch instruction.

In one embodiment, memory instructions that are to be converted into a silent version are predicted at the Branch Processing Unit (BPU) 110 of the processing device 100. The BPU 110 includes switch decision logic 120 that decides whether to switch to another execution control flow (e.g., another thread) in the next cycle. The BPU 110 may provide silencing information to the Front End (FE) 140 to decode instructions appropriately, converting them into their silent version, and to the Back End (BE) 160 to execute them in a non-blocking manner. This whole mechanism allows a smooth flow of instructions that belong to different execution control flows (such as different threads) in the processing device 100 pipeline, overlapping the resolution of long-stalling events with independent work. In addition, non-blocked BE 160 resources can be fully assigned to the other thread, allowing the BE 160 to make progress at full speed.

Throughout the description, reference is made to a processor design executing two threads and including consisting of three main components: (i) a BPU 110 that predicts the outcome of branches and the next Instruction Pointers (RIP) values to fetch from, (ii) an FE 140, that fetches and decodes instructions and (iii) a BE 160 that executes instructions out of order and retires them in order, raising exceptions when appropriate and redirecting the control flow in the presence of branch mispredictions. The BPU 110 and the FE 140 are coupled through a Branch Prediction Queue (BPQ), while the FE 140 and the BE 160 are coupled using an Instruction Queue (IQ). The assumed processor design is used for the sake of ease of discussion. Note, however, that implementation of the disclosure may be extrapolated to different designs, different number of threads, or an implementation on top of an simultaneous (SMT) or Hyperthreading design. In any case, more than two threads may be utilized to achieve a full overlap between computation and event resolution depending on the characteristics of the threads and the latencies to hide.

The BPU 110, FE 140, and BE 160 depicted in FIG. 1 may be extended with additional logic in order to predict delinquent instructions, convert them into their silent version and redirect the execution to another control flow. In particular, embodiments of the disclosure may extend the processor device 100 with the switch decision logic 120 in the BPU 110. The switch decision logic 120 may be responsible for: (i) deciding when to switch to another control flow and (ii) deciding which control flow to switch to. In other words, its role is to predict candidate instructions and to decide whether a switch is desired at particular instances of instructions (i.e., whether the candidate instruction is predicted delinquent instruction or not). A candidate instruction may refer to an instruction that is a candidate to be converted into a silent version of the instruction. In embodiments of the disclosure, load instructions that access normal cacheable memory are considered candidate instructions. All other instruction types (additions, branches, memory instructions accessing non-cacheable memory, etc.) may be considered non-candidate instructions.

A delinquent instruction may refer to a candidate instruction that incurs a significant number of execution cycles due to its execution characteristics and may eventually limit further instruction level parallelism (ILP). For example, a candidate load instruction that misses in the cache 180 and accesses main memory may take several hundred cycles to complete. Such an instruction consumes a ROB entry and a load buffer entry for a significant amount of cycles, potentially affecting performance as a consequence. In particular, a delinquent instruction may refer to a candidate load instruction that misses in the cache 180 (the miss may be for any level of cache, e.g., L1, L2 or L3 miss, etc.), although other load blocking events could also be considered (e.g., dTLB misses, etc.).

Embodiments of the disclosure may also extend the processor device 100 with the BPU switch logic 130 in the BPU 100 and the supporting FE switch logic 150 in the FE 140 and the BE switch logic 170 in the BE 160 for switching. These component s 130, 150, 170 are responsible for (i) coordinating the switching between control flows, (ii) converting predicted delinquent instructions into their equivalent silent instruction and (iii) sending appropriate information to improve the effectiveness of the BPU switch predictor.

In one embodiment, a predicted delinquent instruction refers to a candidate instruction that the frontend of the processor (e.g., the BPU 110 and the FE 140) deems to be delinquent. Whether a predicted delinquent instruction is a real delinquent instruction or not is not known until it executes in the processor backend. A silent instruction may refer to a candidate instruction that: (i) solves the event that causes the stall, (ii) does not block critical resources of the processing device 100, such as ROB entries or load buffer entries, while solving the event, (iii) does not produce an architectural result (i.e., it does not write into a register, it does not write into memory, it does not raise an exception, and it does not increment the instruction pointer (RIP)), and (iv) is re-executed in its original form when the processing device 100 believes the stalling event is resolved. The processing device 100 dynamically converts predicted delinquent instructions into silent instructions in order to overlap the resolution of the event with work of another thread. In some implementations, a silent instruction can be understood as a special prefetch instruction that is created dynamically and that resolves a stalling problem without blocking critical processor resources.

In one embodiment, the BPU 110 continuously predicts the next Instruction Pointer (RIP) from which to fetch instructions and sends it to the FE 140 through the BPQ. The state per thread that the BPU 110 uses to do so includes the current IP address of the thread (IPcur) and the branch prediction history (control_history). In one embodiment, the BPU switch logic 130 extends this state per thread with two additional fields: a silence_degree field and a silence_offset field. The silence_degree and the silence_offset fields may be additional information that the BPU 110 sends to the FE 140 through the BPQ in order to guide the decoding of the instructions by the FE 140. The silence_degree field may take any of the following values: (i) 0 (NONE), meaning that the last fetched instruction of the thread was not silenced, or (ii) 1 (SILENCED_CACHE_MISS), meaning that the last fetched instruction of the thread was silenced due to a predicted cache miss.

A thread with a silence_degree greater than zero (e.g., 1) is considered to be in silenced mode, and it is in regular mode otherwise (e.g., 0). The silence_offset field indicates a byte offset from the predicted currentIP that describes the instruction that is selected for silencing if it is predicted delinquent by switch decision logic 120. This is the case since most BPUs today predict only the nextIP of taken branches and assume fallthru execution of consecutive instructions otherwise.

An algorithm implemented by the BPU switch logic 130 may be summarized in the following piece of pseudocode. Note that actions related to the switch decision logic 120 are identified by the “switch_predictor” keyword, while the actions performed in typical BPU designs are identified by the “traditional_bpu” keyword.

```
control_history[2]
IPcur[2]
silence_degree[2] // 0 = NONE, 1 = SILENCED_CACHE_MISS
silence_offset[2]
cur_flow // pointer to the current thread or flow
switch_flow = false
IPnext = traditional_bpu-
>predict_next_IP_for_current_control_flow(IPcur[cur_flow]),
control_histry[cur_flow])
if (silence_degree[cur_flow] != NONE)
    silence_degree[cur_flow] =
get_new_silence_degree_from_FSM(silence_degree[cur_flow])
    if (silence_degree[cur_flow] != NONE)
        switch_flow = true
else
    <degree, offset> = switch_predictor-
>predict_event_or_events_and_offset(cur_flow,
IPnext, control_history[cur_flow],...) //predict event/events, if any,
that_will_be caused by IPnext and responsible offset (instruction)
if IPnext represents a set of consecutive instructions
    if (degree != NONE)
        switch_flow = true
if (switch_flow)
        IPnext = IPcur[curr_flow]
        silence_degree[cur_flow] = degree
        silence_offset[cur_flow] = offset
send_to_FE_through_BPQ(IPnext,
silence_degree[cur_flow], silence_offset[cur_flow])
IPcur[cur_flow] = IPnext
if (switch_flow)
    cur_flow = switch_predictor->select_next_control_flow( )
```

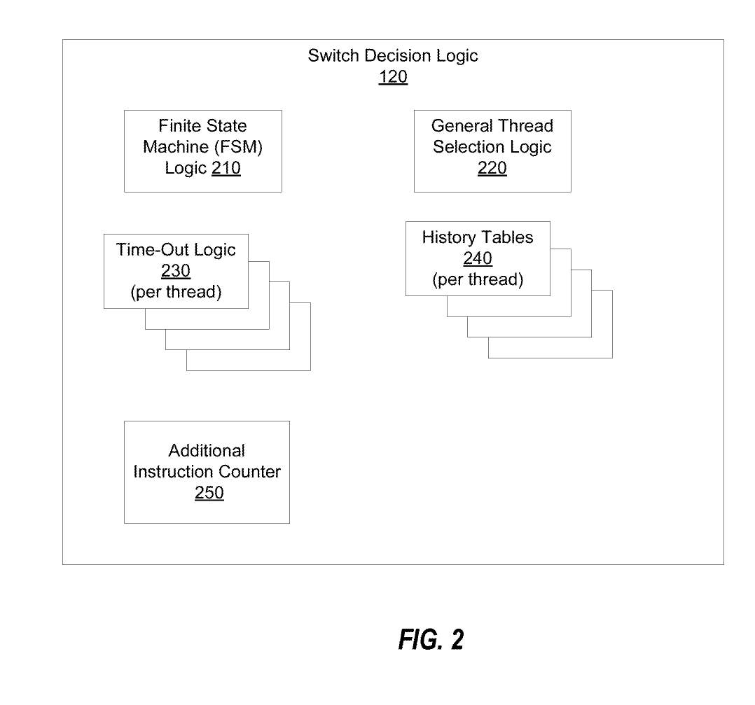

In one embodiment, the BPU 110 first predicts the nextIP of the current thread from the current IP and the branch prediction history of the thread (control_history). The BPU 110 checks the silence_degree of the current thread. If the current thread is in silence mode, the BPU 110 computes the new silence_degree of the current thread using a Finite State Machine (FSM) of switch decision logic 120, which is described in greater detail below with respect to FIG. 2. The FSM shown in FIG. 2 describes the transitions between different silence degrees of a given thread.

After the new silence_degree of the current thread is computed, the BPU switch logic 130 of the BPU 110 also forces a thread switch from the current (silenced) thread to the other thread and does not update its current IP (so that the silenced instruction is re-executed once the thread moves back to regular mode). The BPU 110 then accesses the switch decision logic 120 that may decide to predict any of the instructions following the next predicted RIP to be delinquent or not. The switch decision logic 120 then returns the silence_degree and the corresponding offset (if necessary).

The extensions in the FE 140 for more than two threads may assume that a round robin is applied among them. In other words, for 4 threads, instructions from thread 0 are fetched first, then instructions from thread 1, then instructions from thread 2, from thread 3 and again from thread 0 and so on. Note, however, that other techniques and heuristics may be developed and used to choose different threads to fetch from.

The FE 140 receives <next RIP, silence_degree, silence_offset> triplets from the BPU 110, decodes instructions accordingly and sends decoded instructions to the BE 160 through the Instruction Queue (IQ). Furthermore, the FE 160 additionally sends information to the BPU 110 when the BPU 110 makes incorrect decisions. For example, if the BPU 110 has predicted that there is a branch instruction at address X and the FE 140 sees this is not the case while decoding, the FE 140 sends a signal to the BPU 110 and re-steer the BPU 110.

Implementations of the disclosure extend the FE 140 with FE switch logic 150 to perform actions, such as those described by the following pseudocode. The actions performed by traditional FE designs are identified by the keyword “traditional_fe”.

```
traditional_fe-
>fetch_next_instruction_from_IPnext_and_current_offset
traditional_fe->decode_the_instruction
if (silence_degree != NONE) at current offset
    if (decoded_instruction_is_not_candidate)
        send_silence_decode_error_to_BPU // si_clear signal
    if (silence_degree != SILENCED_CACHE_MISS)
        decode_decoded_instruction_as_special_dTLB_prefetch_instruction
    else // silence degree is not NONE, so it needs to be
SILENCED_CACHE_MISS at this point
        decoded_instruction_as_a_special_cache_prefetch_instruction
traditional_fe->send_decoded_inst_to_IDQ
```

Once the FE 140 observes an instruction predicted as a delinquent instruction (e.g., its associated silence_degree is above zero), the FE switch logic 150 checks whether the decoded instruction is indeed a candidate instruction. At this point of the pipeline, the processing device 100 knows whether the decoded instruction is indeed a load instruction, but it does not know if the instruction accesses cacheable memory or not (this is known in the BE 160, once the instruction is executed and its memory address computed). Thus, if the predicted delinquent instruction is not a load instruction, the FE 140 sends a silent clear (si_clear) signal to the BPU 110 and resteers the BPU 110. The BPU 110 uses this information to update the switch decision logic 120 in order to enhance the delinquent predictions and continue predicting correct <next IP, silence degree, silence offset>triplets from that execution point.

On the other hand, if the predicted delinquent instruction is a candidate instruction, the FE switch logic 150 checks the silence degree attached by the BPQ. If the silence degree is 0 (NONE), the FE 140 does not perform any additional actions and the instruction proceeds to the IQ as is. If the predicted delinquent instruction is a load instruction with a silence degree of 1 (SILENCED_CACHE_MISS), the FE 140 decodes the instruction as a special cache prefetch instruction. This decoding logic is consistent with the FSM presented in FIG. 2 and discussed in greater detail below.

The BE 160 is responsible for the execution (e.g., out-of-order) and the retirement (e.g., in order) of instructions, raising exceptions when they occur and updating the architectural state. In embodiments of the disclosure, the BE 160 is extended with BE switch support 170 spread among different BE units or clusters for (i) executing the new special prefetch instructions, (ii) retiring the predicted delinquent instructions and (iii) sending execution information to the BPU 110 in order to update the switch predictor, since it is at this point where the processor knows if a predicted delinquent instruction behaved indeed delinquently.

The main goal of the special cache prefetch instruction is to bring data to the data cache 180 so that when the regular load instruction is executed, the datum is most likely to be found in the L1 data cache. As such, these instructions do not have a destination register. Similar to explicit prefetch instructions, if a special cache prefetch instruction suffers a dTLB miss, it activates a page walk automata that executes in the background in order to find a proper virtual-to-physical address mapping in the page tables of the processing device 100. A main difference between a special cache prefetch instruction and a regular explicit prefetch instruction is that when the instruction reaches the head of the ROB: (i) the instruction does not update the architectural RIP value, and (ii) the instruction does not raise exceptions in case the mapping from virtual-to-physical generates any errors.

The BE 160 is also responsible for sending information about the execution of the instructions to the BPU for the BPU 110 to utilize in updating the switch decision logic 120 to improve its accuracy. Thus, upon execution of a load instruction or its silent versions (i.e., special cache prefetch), the BE 160 sends feedback to the BPU 110. This feedback loop includes, but is not limited to: (i) the particular load instruction instance was a candidate instruction (it accessed cacheable memory), or (ii) the particular load instruction instance incurred in a cache miss.

In one embodiment, the BE 160 is also responsible for sending switching hints to the BPU 110 and the switch decision logic 120 when it deems that a particular event has been resolved. A mechanism based on hinting a thread switch after several instructions of a given thread have been executed may be utilized for the switching hints sent to the BPU 110.

FIG. 2 illustrates a block diagram of switch decision logic 120, according to an embodiment of the disclosure. In one embodiment, switch decision logic 120 is part of a BPU, such as BPU 110 of FIG. 1, and is the same as switch decision logic 120 described with respect to FIG. 1. In one embodiment, switch decision logic 120 shown in FIG. 2 may be utilized to provide silent memory instructions and miss-rate tracking to optimize switching policy on threads in a processing device.

As illustrated in FIG. 2, the switch decision logic 120 may include a FSM 210 to coordinate the instruction flow after the BPU 110 predicts an instruction as a delinquent instruction. The switch decision logic 120 detects potential delinquent instructions by assigning them a silence degree other than NONE. Once this occurs, the corresponding thread is in silent mode. Otherwise, the thread is in normal execution mode. If the switch decision logic 120 predicts an instruction to be a cache miss (SILENCED_CACHE_MISS state), the BPU passes on this information to the FE, which decodes the instruction as a special cache prefetch in order to solve the cache miss and the BPU switches to the other thread. Once control is given back to the first thread, the silence degree of the considered instruction is to be NONE, the thread moves to normal execution mode, and the instruction proceeds through the pipeline as a regular memory operation. This is why there is a transition from SILENCED_CACHE_MISS to NONE.

Switch decision logic 120 also includes general thread selection logic 220, which utilizes data-miss history information to determine when to perform thread switches and which thread to pick in order to reduce the probability of execution stalls. The data miss history information may include, but is not limited to, tracking and identification of prefetch/loads instructions with a high miss-rate inside a history table 240 (instruction pointer based) to predict the miss-rate of each such prefetch/load and use it with additional cycle-counters 230 per thread information to decide when to perform the thread switch and to which thread to switch. In one embodiment, the general thread selection logic 220 implements a heuristic that selects as a next active thread, the thread with the lowest estimated probability for stalls using the cycle counters.

The switch decision logic 120 tracks prefetch/load instructions using an RIP-based history table 240 for each thread. When a load instruction is allocated at this table, the cache controller sends a hit/miss indication that is used to calculate the miss-rate per thread (e.g. 70/100, etc.) Furthermore, the switch decision logic 120 includes time-out logic 230 per thread. The time-out logic 230 may include a time-out down counter that is based on estimated average cache-miss latency and the miss-rate. In one embodiment, during a switch, the time-out down counter is loaded with average miss latency multiplied by the miss-rate. In other embodiments, a different formula may be used to load the time-out down counter with an initial value. For example, the formula may be any equation that evaluates cache-miss latency and miss-rate.

The general thread selection logic 220 access the time-out logic 230 and history tables 240 to select the thread with the lower counter value (=low probability of stalls) and lowest predicted miss rate to switch into. For example, if an average cache-miss latency for a certain RIP is ˜300 cycles and the miss-rate for a load is 100% then the general thread selection logic 220 may determine to switch to another thread and try to wait at least 300 cycles before going back to this thread. On the other hand, if miss-rate is 50%, the general thread selection logic 220 may determine to wait at least 150 cycles. In some cases, the decision may be to stay at a current thread execution context (i.e., no switch).

In some implementations, if the counters at time-out logic 230 reach zero, the general thread selection logic 220 may select threads in a round-robin fashion, in order to minimize the frequency of switch occurrences.

In one implementation, an additional instruction counter 250 is utilized to provide a fairness measure. The additional instruction counter 250 may ensure that at every N instruction the switch decision logic 120 causes a thread context switch.

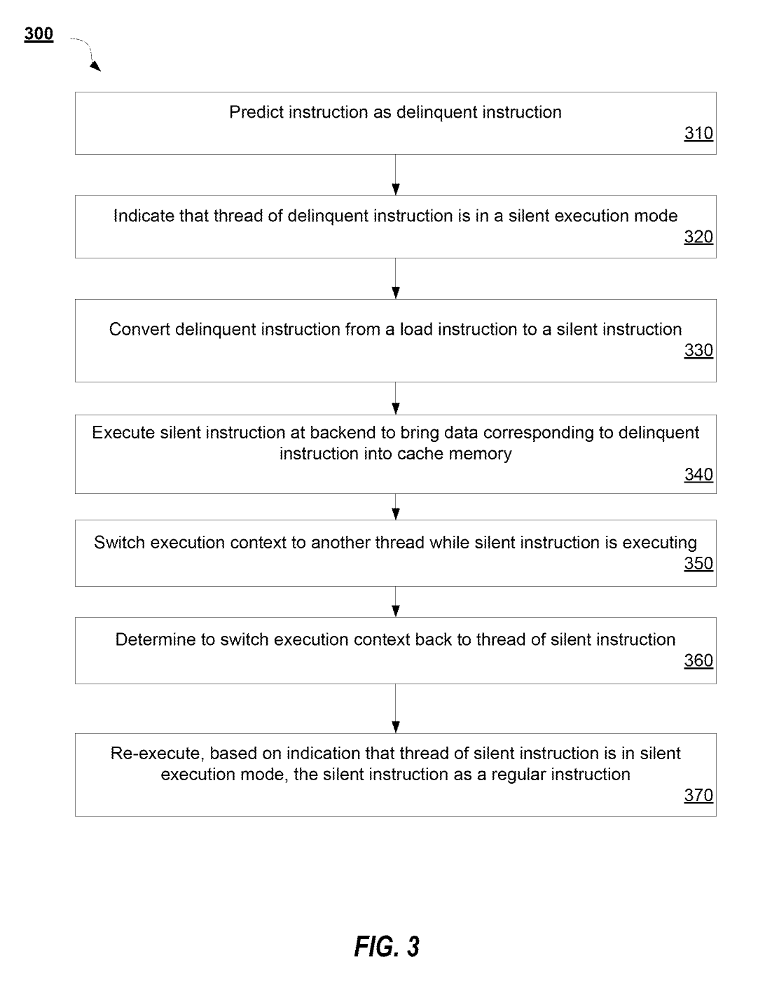

FIG. 3 is a flow diagram illustrating a method 300 for implementing silent memory instructions to optimize switching policy on threads in a processing device according to an implementation of the disclosure. Method 300 may be performed by processing logic that may comprise hardware (e.g., circuitry, dedicated logic, programmable logic, microcode, etc.), software (such as instructions run on a processing device), firmware, or a combination thereof. In one embodiment, method 300 is performed by processing device 100 of FIG. 1.

Method 300 begins at block 310 where an instruction of a thread is predicted to be a delinquent instruction. Then, at block 320, the thread having the predicted delinquent instruction is indicated to be executing in a silent execution mode. At block 330, the delinquent instruction is converted from a load instruction to a silent instruction. In one embodiment, the silent instruction is a special prefetch instruction.

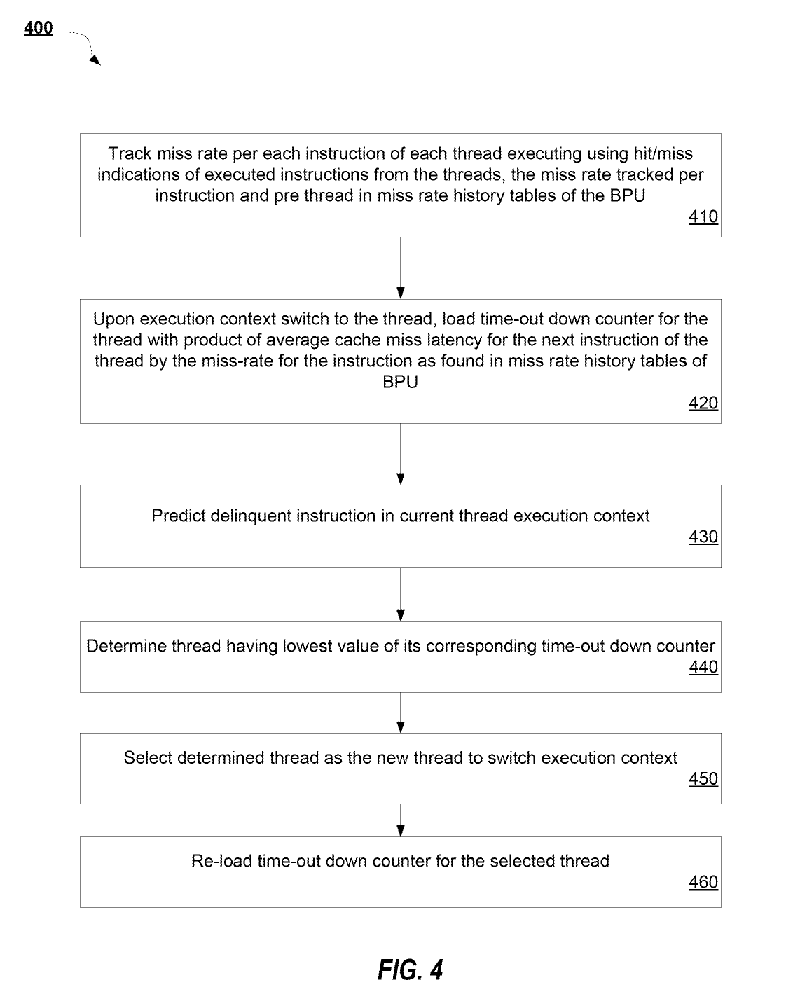

Subsequently, at block 340, the silent instruction is executed at a backend in order to bring data corresponding to the delinquent instruction into cache memory. At block 350, an execution context of the processing device is switched to another thread while the silent instruction is executing. Then, at block 360, it is determined to switch the execution context back to the thread having the silent instruction. In one implementation, the execution context may switch upon another thread having a predicted delinquent instruction. In other implementations, the execution context may switch based upon method 400 described with respect to FIG. 4 below.

Lastly, at block 370, the silent instruction is re-executed as a regular instruction. In one implementation, the re-execution of the silent instruction occurs due to the indication that the thread of the silent instruction is running in a silent execution mode. If the thread was indicated as running in a regular mode, then execution at the thread would have resumed at a next un-executed instruction of the thread.

FIG. 4 is a flow diagram illustrating a method 400 for silent memory instructions and miss-rate tracking to optimize switching policy on threads in a processing device according to an implementation of the disclosure. Method 400 may be performed by processing logic that may comprise hardware (e.g., circuitry, dedicated logic, programmable logic, microcode, etc.), software (such as instructions run on a processing device), firmware, or a combination thereof. In one embodiment, method 400 is performed by switch decision logic 120 of FIGS. 1 and 2.

Method 400 begins at block 410 where a miss rate is tracked per each instruction of each thread of a processing device. In one implementation, the miss rate is tracked by utilizing hit/miss indicators associated with previously-executed instructions from the threads. The miss rates may be tracked in miss rate history tables of a BPU. At block 420, upon an execution context switch to any of the tracked threads, a time-out down counter is loaded for the thread. In one implementation, the time-out down counter is loaded with a value equal to the product of an average cache miss latency for a next instruction of the thread by the miss rate for the instruction as tracked in the miss rate history table for the thread.

Subsequently, at block 430, a delinquent instruction is predicted in a current thread execution context. Then, at block 440, a thread having a lowest value of its corresponding time-out down counter is determined. At block 450, the determined thread with the lowest time-out down counter value is selected as the new thread to switch the execution context. If multiple threads have an equal lowest value, then a round robin technique may be implemented to select the thread for the execution context switch. Lastly, at block 460, the time-out counter for the selected thread is re-loaded with a value similar to the value calculated at block 420.

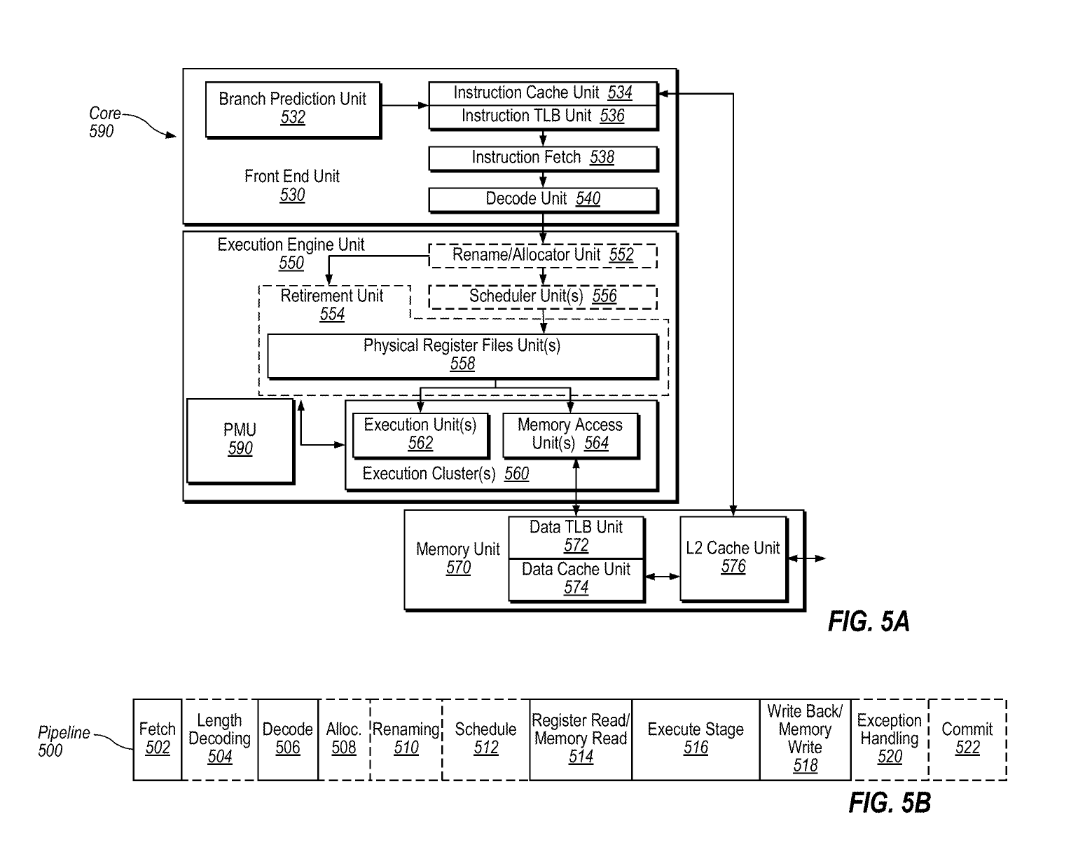

FIG. 5A is a block diagram illustrating a micro-architecture for a processor 500 that implements silent memory instructions and miss-rate tracking to optimize switching policy on threads in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

In one implementation, processor 500 may be the same as processing device 100 described with respect to FIG. 1. In particular, the branch prediction unit 532 may be the same as BPU 110 described with respect to FIG. 1, to implement silent memory instructions and miss-rate tracking to optimize switching policy on threads in a processing device described with respect to implementations of the disclosure.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processing device 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

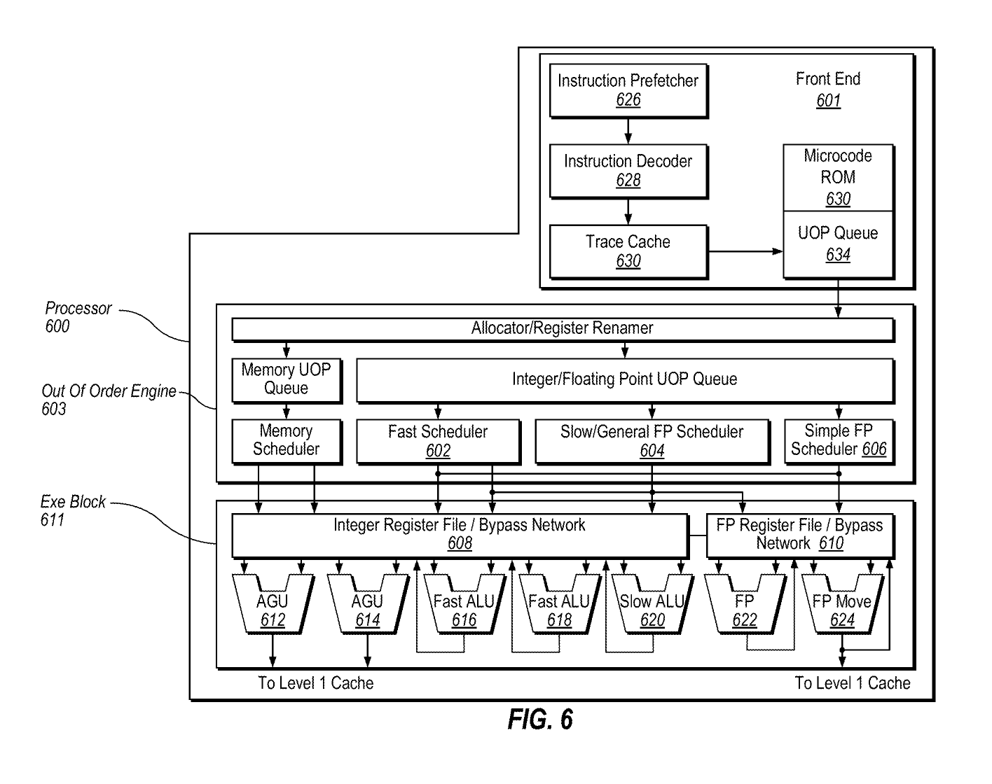

FIG. 6 illustrates a block diagram of the micro-architecture for a processor 600 that includes logic circuits to implement silent memory instructions and miss-rate tracking to optimize switching policy on threads in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing silent memory instructions and miss-rate tracking to optimize switching policy on threads.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMXTM registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

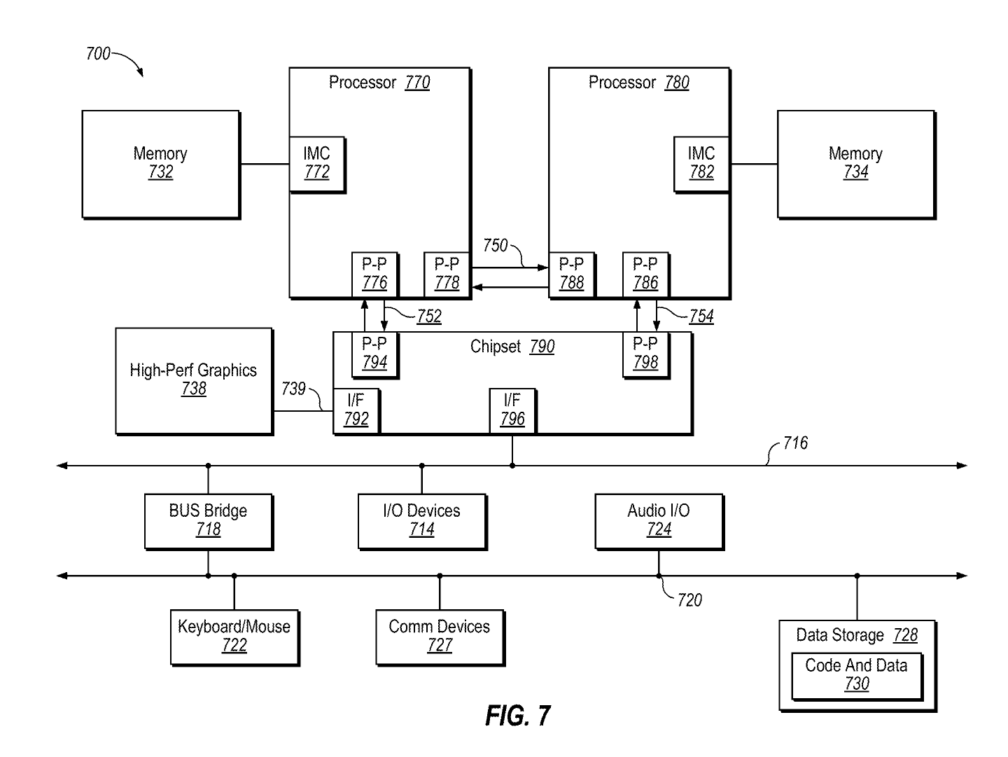

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement silent memory instructions and miss-rate tracking to optimize switching policy on threads as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

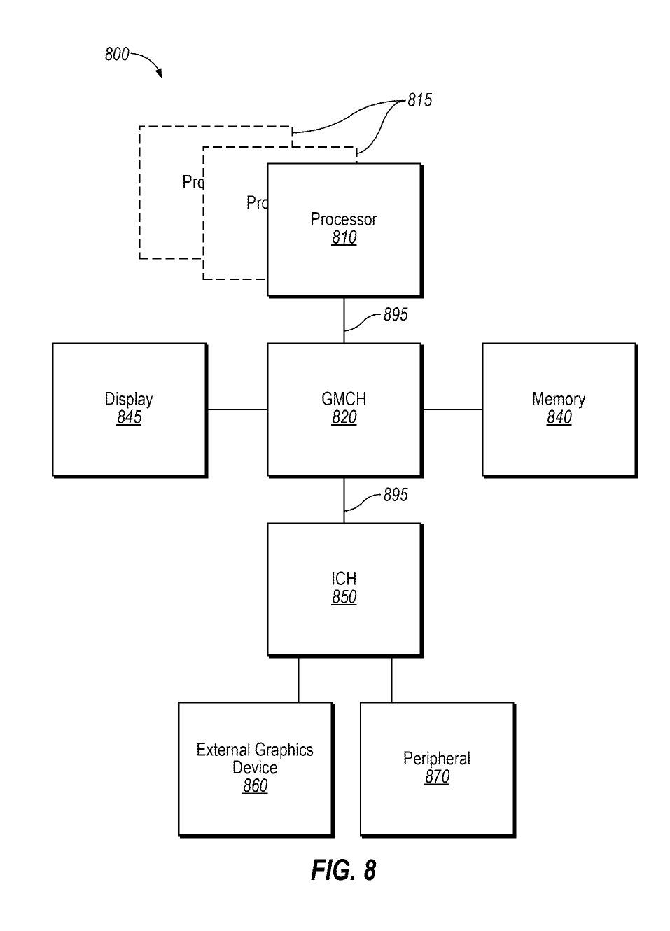

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement silent memory instructions and miss-rate tracking to optimize switching policy on threads according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

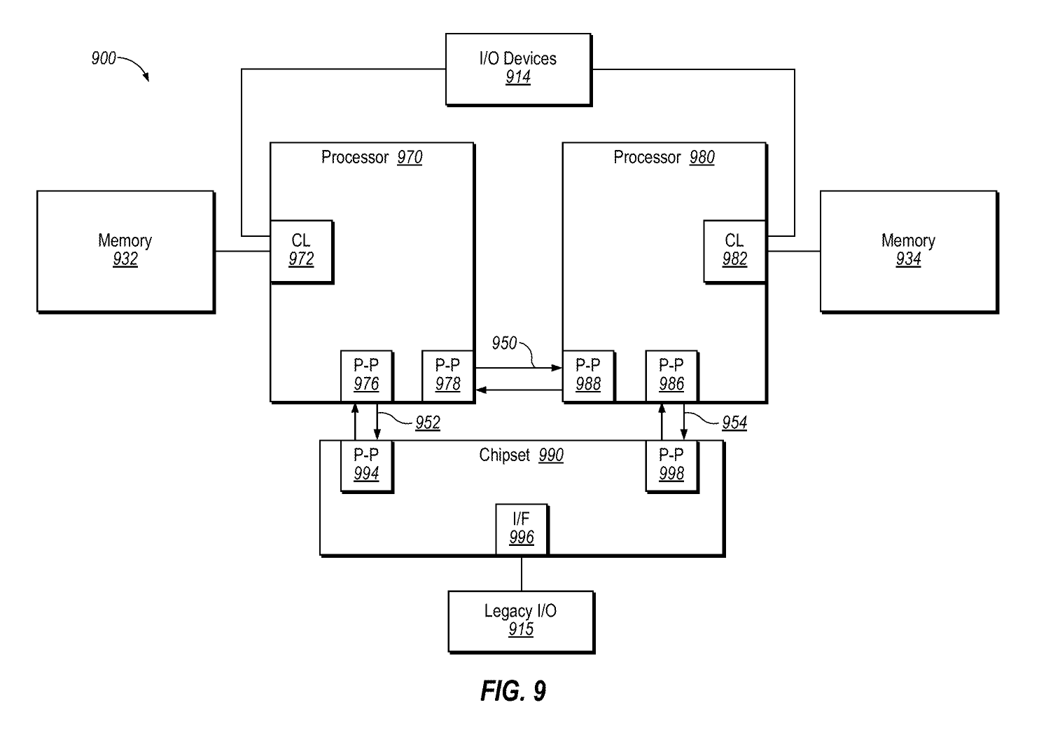

Referring now to FIG. 9, shown is a block diagram of a system 900 in which an embodiment of the disclosure may operate. FIG. 9 illustrates processors 970, 980. In one embodiment, processors 970, 980 may implement silent memory instructions and miss-rate tracking to optimize switching policy on threads as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

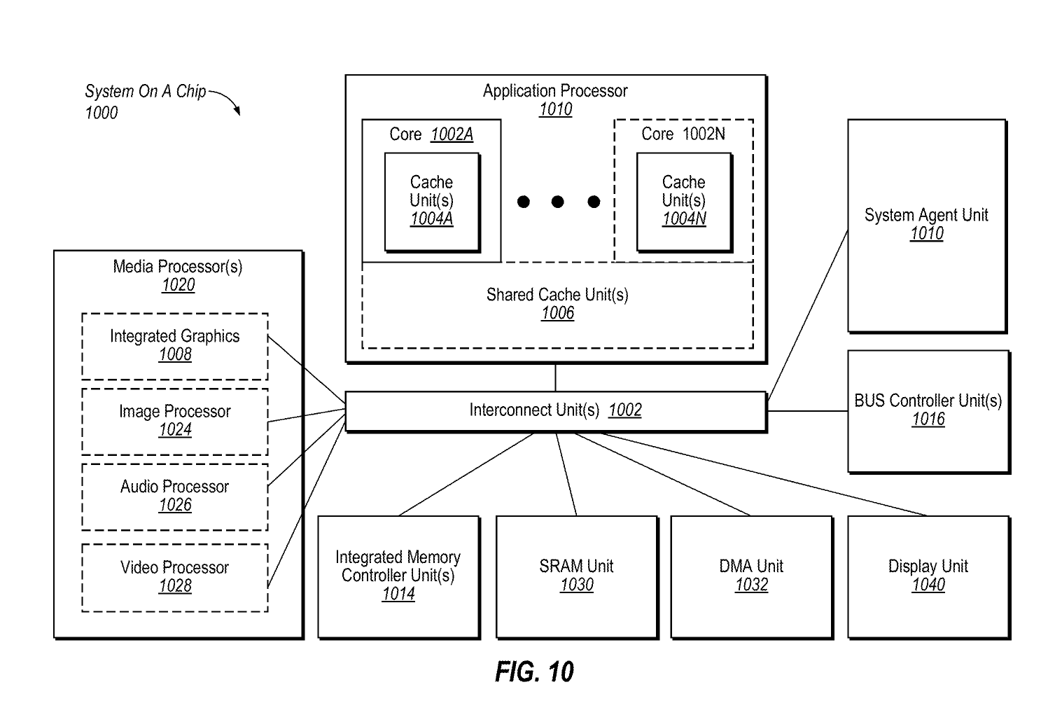

Embodiments may be implemented in many different system types. FIG. 10 is a block diagram of a SoC 1000 in accordance with an embodiment of the present disclosure. Dashed lined boxes are optional features on more advanced SoCs. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a PMU for implementing silent memory instructions and miss-rate tracking to optimize switching policy on threads as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

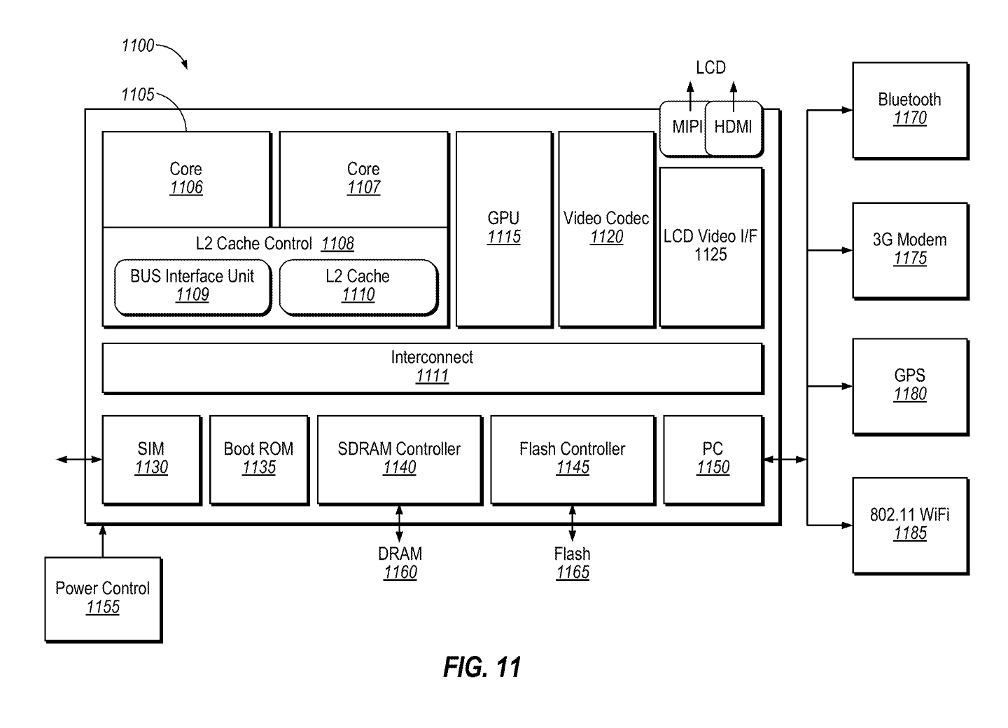

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement silent memory instructions and miss-rate tracking to optimize switching policy on threads as described in embodiments herein.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

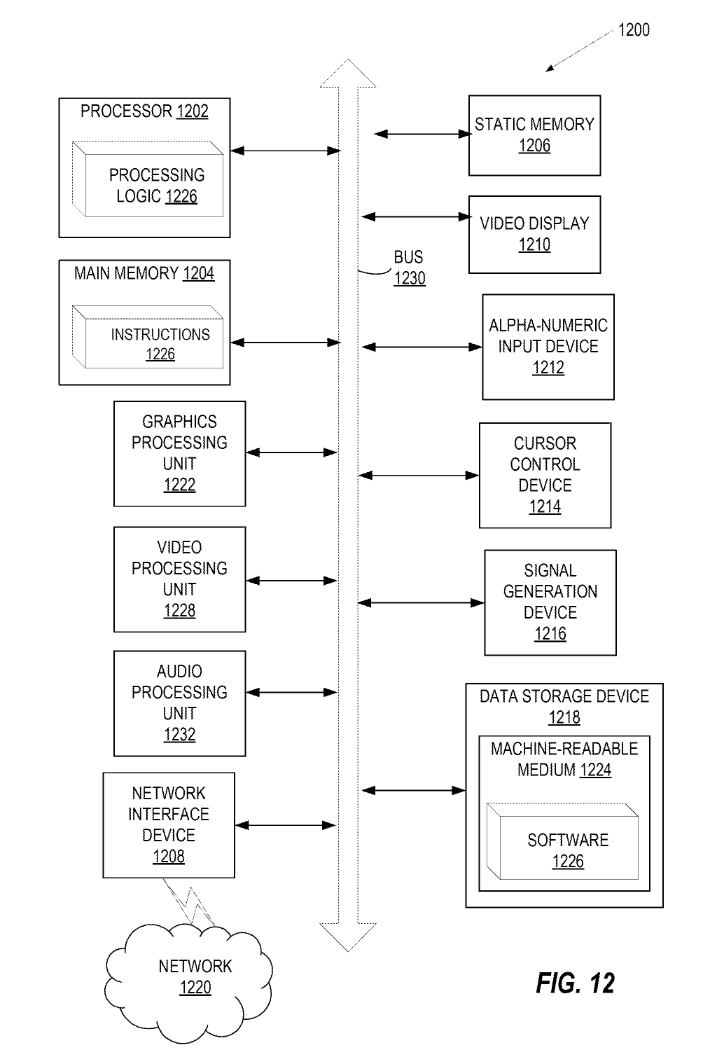

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the processing logic 1226 for performing the operations and steps discussed herein. In one embodiment, processing device 1202 is the same as processor architecture 100 described with respect to FIG. 1 that implements silent memory instructions and miss-rate tracking to optimize switching policy on threads as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing silent memory instructions and miss-rate tracking to optimize switching policy on threads in a processing device as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing silent memory instructions and miss-rate tracking to optimize switching policy on threads in a processing device such as described with respect to processing device 100 in FIG. 1, and/or a software library containing methods that call the above applications. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processing device for implementing silent memory instructions and miss-rate tracking to optimize switching policy on threads. Further to Example 1, the processing device comprises a branch prediction unit (BPU) to predict that an instruction of a first thread in a current execution context of the processing device is a delinquent instruction, indicate that the first thread including the delinquent instruction is in a silent execution mode, indicate that the delinquent instruction is to be executed as a silent instruction, switch an execution context of the processing device to a second thread, and when the execution context returns to the first thread, cause the delinquent instruction to be re-executed as a regular instruction.

In Example 2, the subject matter of Example 1 can optionally include wherein the delinquent instruction comprises a load instruction predicted to incur a cache miss. In Example 3, the subject matter of any one of Examples 1-2 can optionally include wherein the silent instruction comprises a special prefetch instruction. In Example 4, the subject matter of any one of Examples 1-3 can optionally include further comprising a front end (FE) unit to decode the delinquent instruction for execution as the silent instruction, and send the silent instruction to a back end (BE) unit for execution.

In Example 5, the subject matter of any one of Examples 1-4 can optionally include further comprising the BE unit to execute the silent instruction and re-execute the silent instruction as a regular instruction. In Example 6, the subject matter of any one of Examples 1-5 can optionally include wherein instructions of the second thread are executed while the silent instruction is processed. In Example 7, the subject matter of any one of Examples 1-6 can optionally include wherein the BPU further to track a miss rate for each instruction of each thread of the processing device, where the each thread comprises at least the first thread and the second thread.

In Example 8, the subject matter of any one of Examples 1-7 can optionally include wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction. In Example 9, the subject matter of any one of Examples 1-8 can optionally include wherein the BPU selects a thread having a lowest value of its corresponding time-out down counter to receive an execution context switch of the processing device. All optional features of the apparatus described above may also be implemented with respect to the method or process described herein.

Example 10 is a method for silent memory instructions and miss-rate tracking to optimize switching policy on threads comprising predicting, by a processing device, that an instruction of a first thread in a current execution context of the processing device is a delinquent instruction, indicating that the first thread including the delinquent instruction is in a silent execution mode, indicating that the delinquent instruction is to be executed as a silent instruction, switching an execution context of the processing device to a second thread, and when the execution context returns to the first thread, causing the delinquent instruction to be re-executed as a regular instruction.

In Example 11, the subject matter of Example 10 can optionally include wherein the delinquent instruction comprises a load instruction predicted to incur a cache miss. In Example 12, the subject matter of any one of Examples 10-11 can optionally include wherein the silent instruction comprises a special prefetch instruction.

In Example 13, the subject matter of any one of Examples 10-12 can optionally include further comprising decoding the delinquent instruction for execution as the silent instruction, and executing the silent instruction. In Example 14, the subject matter of any one of Examples 10-13 can optionally include wherein a back end (BE) unit of the processing device perform the executing the silent instruction and re-executing the silent instruction as a regular instruction.

In Example 15, the subject matter of any one of Examples 10-14 can optionally include wherein instructions of the second thread are executed while the silent instruction is processed. In Example 16, the subject matter of any one of Examples 10-15 can optionally include wherein the BPU further to track a miss rate for each instruction of each thread of the processing device, where the each thread comprises at least the first thread and the second thread.

In Example 17, the subject matter of any one of Examples 10-16 can optionally include wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction. In Example 18, the subject matter of any one of Examples 10-17 can optionally include wherein the BPU selects a thread having a lowest value of its corresponding time-out down counter to receive an execution context switch of the processing device.

Example 19 is a system for implementing silent memory instructions and miss-rate tracking to optimize switching policy on threads. In Example 19, the system includes a cache memory and a branch prediction unit (BPU) communicably coupled to the cache memory. Further to Example 19, the BPU is to predict that an instruction of a first thread in a current execution context of the processing device is a delinquent instruction, indicate that the first thread including the delinquent instruction is in a silent execution mode, indicate that the delinquent instruction is to be executed as a silent instruction, wherein the silent instruction loads data from a memory to the cache memory, switch an execution context of the processing device to a second thread, and when the execution context returns to the first thread, cause the delinquent instruction to be re-executed as a regular instruction.

In Example 20, the subject matter of Example 19 can optionally include wherein the delinquent instruction comprises a load instruction predicted to incur a cache miss. In Example 21, the subject matter of Examples 19-20 can optionally include wherein the silent instruction comprises a special prefetch instruction. In Example 22, the subject matter of any one of Examples 19-21 can optionally include further comprising a front end (FE) unit to decode the delinquent instruction for execution as the silent instruction, and send the silent instruction to a back end (BE) unit for execution.

In Example 23, the subject matter of any one of Examples 19-22 can optionally include further comprising the BE unit to execute the silent instruction and re-execute the silent instruction as a regular instruction. In Example 24, the subject matter of any one of Examples 19-23 can optionally include wherein instructions of the second thread are executed while the silent instruction is processed.

In Example 25, the subject matter of any one of Examples 19-24 can optionally include wherein the BPU further to track a miss rate for each instruction of each thread of the processing device, where the each thread comprises at least the first thread and the second thread. In Example 26, the subject matter of any one of Examples 19-25 can optionally include wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction.

In Example 27, the subject matter of any one of Examples 19-26 can optionally include wherein the BPU selects a thread having a lowest value of its corresponding time-out down counter to receive an execution context switch of the processing device. All optional features of the system described above may also be implemented with respect to the method or process described herein.

Example 28 is a non-transitory computer-readable medium for implementing silent memory instructions and miss-rate tracking to optimize switching policy on threads. In Example 28, the non-transitory machine-readable medium includes data that, when accessed by a processing device, cause the processing device to perform operations comprising predicting, by the processing device, that an instruction of a first thread in a current execution context of the processing device is a delinquent instruction, indicating that the first thread including the delinquent instruction is in a silent execution mode, indicating that the delinquent instruction is to be executed as a silent instruction, switching an execution context of the processing device to a second thread, and when the execution context returns to the first thread, causing the delinquent instruction to be re-executed as a regular instruction.

In Example 29, the subject matter of Example 28 can optionally include wherein the delinquent instruction comprises a load instruction predicted to incur a cache miss. In Example 30, the subject matter of Examples 28-29 can optionally include wherein the silent instruction comprises a special prefetch instruction. In Example 31, the subject matter of Examples 28-30 can optionally include wherein the operations further comprise decoding the delinquent instruction for execution as the silent instruction, and executing the silent instruction.

In Example 32, the subject matter of Examples 28-31 can optionally include wherein a back end (BE) unit of the processing device perform the executing the silent instruction and re-executing the silent instruction as a regular instruction. In Example 33, the subject matter of Examples 28-32 can optionally include wherein instructions of the second thread are executed while the silent instruction is processed.

In Example 34, the subject matter of Examples 28-33 can optionally include wherein the BPU further to track a miss rate for each instruction of each thread of the processing device, where the each thread comprises at least the first thread and the second thread. In Example 35, the subject matter of Examples 28-34 can optionally include wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction. In Example 36, the subject matter of Examples 28-35 can optionally include wherein the BPU selects a thread having a lowest value of its corresponding time-out down counter to receive an execution context switch of the processing device.

Example 37 is an apparatus for implementing silent memory instructions and miss-rate tracking to optimize switching policy on threads comprising means for predicting, by the processing device, that an instruction of a first thread in a current execution context of the processing device is a delinquent instruction, means for indicating that the first thread including the delinquent instruction is in a silent execution mode, means for indicating that the delinquent instruction is to be executed as a silent instruction, means for switching an execution context of the processing device to a second thread, and means for when the execution context returns to the first thread, causing the delinquent instruction to be re-executed as a regular instruction. In Example 38, the subject matter of Example 37 can optionally include the apparatus further configured to perform the method of any one of the Examples 11 to 18.

Example 39 is at least one machine readable medium comprising a plurality of instructions that in response to being executed on a computing device, cause the computing device to carry out a method according to any one of Examples 10-18. Example 40 is an apparatus for silent memory instructions and miss-rate tracking to optimize switching policy on threads, configured to perform the method of any one of Examples 10-18. Example 41 is an apparatus for implementing silent memory instructions and miss-rate tracking to optimize switching policy on threads comprising means for performing the method of any one of claims 10 to 19. Specifics in the Examples may be used anywhere in one or more embodiments.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processing device, comprising:
a branch prediction unit (BPU) to:
predict that an instruction of a first thread in a current execution context of the processing device is a delinquent instruction;
indicate that the first thread including the delinquent instruction is in a silent execution mode;
indicate that the delinquent instruction is to be executed as a silent instruction;
switch an execution context of the processing device to a second thread; and
when the execution context returns to the first thread, cause the delinquent instruction to be re-executed as a regular instruction.

2. The processing device of claim 1, wherein the delinquent instruction comprises a load instruction predicted to incur a cache miss.

3. The processing device of claim 1, wherein the silent instruction comprises a special prefetch instruction.

4. The processing device of claim 1, further comprising a front end (FE) unit to:
decode the delinquent instruction for execution as the silent instruction; and
send the silent instruction to a back end (BE) unit for execution.

5. The processing device of claim 4, further comprising the BE unit to execute the silent instruction and re-execute the silent instruction as a regular instruction.

6. The processing device of claim 1, wherein instructions of the second thread are executed while the silent instruction is processed.

7. The processing device of claim 1, wherein the BPU further to track a miss rate for each instruction of each thread of the processing device, where the each thread comprises at least the first thread and the second thread.

8. The processing device of claim 7, wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction.

9. The processing device of claim 8, wherein the BPU selects a thread having a lowest value of its corresponding time-out down counter to receive an execution context switch of the processing device.

10. A method, comprising:
predicting, by a processing device, that an instruction of a first thread in a current execution context of the processing device is a delinquent instruction;
indicating that the first thread including the delinquent instruction is in a silent execution mode;
indicating that the delinquent instruction is to be executed as a silent instruction;
switching an execution context of the processing device to a second thread; and
when the execution context returns to the first thread, causing the delinquent instruction to be re-executed as a regular instruction.

11. The method of claim 10, wherein the delinquent instruction comprises a load instruction predicted to incur a cache miss.

12. The method of claim 10, wherein the silent instruction comprises a special prefetch instruction.

13. The method of claim 10, further comprising:
decoding the delinquent instruction for execution as the silent instruction; and
executing the silent instruction.

14. The method of claim 10, wherein instructions of the second thread are executed while the silent instruction is processed.

15. The method of claim 10, wherein the BPU further to track a miss rate for each instruction of each thread of the processing device, where the each thread comprises at least the first thread and the second thread.

16. The method of claim 15, wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction.

17. An system comprising:
a cache memory; and
a branch prediction unit (BPU) communicably coupled to the cache memory, the BPU to:
predict that an instruction of a first thread in a current execution context of the processing device is a delinquent instruction;
indicate that the first thread including the delinquent instruction is in a silent execution mode;
indicate that the delinquent instruction is to be executed as a silent instruction, wherein the silent instruction loads data from a memory to the cache memory;
switch an execution context of the processing device to a second thread; and
when the execution context returns to the first thread, cause the delinquent instruction to be re-executed as a regular instruction.

18. The system of claim 17, wherein the delinquent instruction comprises a load instruction predicted to incur a cache miss.

19. The system of claim 17, wherein the silent instruction comprises a special prefetch instruction.

20. The system of claim 17, further comprising a front end (FE) unit to:
decode the delinquent instruction for execution as the silent instruction; and
send the silent instruction to a back end (BE) unit for execution, wherein the BE unit to execute the silent instruction and re-execute the silent instruction as a regular instruction.

21. The system of claim 17, wherein instructions of the second thread are executed while the silent instruction is processed.

22. The system of claim 17, wherein the BPU further to track a miss rate for each instruction of each thread of the processing device, where the each thread comprises at least the first thread and the second thread.

23. The system of claim 22, wherein the BPU further comprises a time-out down counter for the each thread, the time-out down counter initialized upon a context switch to the corresponding thread with a value comprising a product of multiplying the tracked miss rate for a next instruction of the corresponding thread by an average cache miss latency for the next instruction.
